(19) United States
(12) Patent Application Publication
(10) Pub. No.: US 2014/0130953 A1
(43) Pub. Date: May 15, 2014

(54) BICYCLE WHEEL RIM AND A BICYCLE WHEEL ASSEMBLY INCLUDING THE SAME

(71) Applicant: ALEX GLOBAL TECHNOLOGY, INC., Tainan City (TW)

(72) Inventor: Wei-Chin CHEN, Tainan City (TW)

(73) Assignee: ALEX GLOBAL TECHNOLOGY, INC., Tainan City (TW)

(21) Appl. No.: 14/080,263

(22) Filed: Nov. 14, 2013

(30) Foreign Application Priority Data
Nov. 15, 2012 (TW) 101142628

(51) Int. Cl. B60B 21/10

(52) U.S. Cl. CPC B60B 21/104
USPC 152/375; 301/95.104

(57) ABSTRACT

A bicycle wheel rim for mounting with two tire rim portions of a tire includes an outer ring wall surrounding a rotation axis of the wheel rim, and two annular flanges. Each annular flange has an inclined inner surface for abutting against a respective one of the tire rim portions. The outer ring wall has two retaining surfaces, each extending from the corresponding one of the annular flanges toward the central radial plane of the wheel rim and being inclined radially and outwardly with respect to the rotation axis. Each retaining surface and a corresponding inclined inner surface cooperatively form therebetween an included angle smaller than 90 degrees, and clamp the respective one of the tire rim portions.

### CROSS-REFERENCE TO RELATED APPLICATION

This application claims priority to Taiwanese Application No. 101142628, filed on Nov. 15, 2012.

### BACKGROUND OF THE INVENTION

1. Field of the Invention

The invention relates to a wheel rim, and more particularly to a bicycle wheel rim able to secure tire rim portions of a tire, and to a bicycle wheel rim assembly including the bicycle wheel rim.

2. Description of the Related Art

Generally, a bicycle wheel rim is designed to have either a single-layer structure or a two-layer structure. As shown in FIG. 1, U.S. Pat. No. 8,007,053 B2 discloses a conventional bicycle wheel rim 1 with the two-layer structure that is adapted for mounting a tire 10 thereon. The tire 10 has a pair of annular tire rim portions 101 that are spaced apart from each other in a left-right direction. The conventional bicycle wheel rim 1 includes a pair of annular flanges 11 that are symmetric in the left-right direction, and an annular base portion 12 interconnecting the annular flanges 11. The base portion 12 has an inner ring wall 121 surrounding a rotation axis of the conventional bicycle wheel rim 1, and an outer ring wall 122 surrounding the inner ring wall 121. The inner ring wall 121 is adapted for mounting a plurality of wheel spokes thereon (not shown). The outer ring wall 122 includes a pair of connection sections 123, each of which is connected to a corresponding one of the annular flanges 11.

Each of the annular flanges 11 has a parallel section 111 that is connected to the base portion 12 and that extends parallel to a central radial plane 13 of the conventional bicycle wheel rim 1, and a curved section 112 that extends outwardly and radially from an outermost end of the parallel section 111 distal from the base portion 12 and that is arcuately bent toward the central radial plane 13. The curved section 112 has a thickness that is substantially equal to that of the parallel section 111. The parallel section 111 has an inner upright surface 113 that extends parallel to the central radial plane 13, and a curved surface 114 interconnecting the inner upright surface 113 and a corresponding one of the connection sections 123.

During assembling, each of the tire rim portions 101 of the tire 10 abuts against the inner upright surface 113 and the curved surface 114 of a corresponding one of the annular flanges 11, so that the curved section 112 of the corresponding annular flange 11 is hookedly engaged with the corresponding tire rim portion 101.

The conventional bicycle wheel rim 1 primarily relies on the curved sections 112 of the annular flanges 11 for securing the tire rim portions 101 of the tire 10 on the conventional wheel rim 1. However, a force acted on the conventional bicycle wheel rim 1 by the tire 10 is primarily concentrated on the curved sections 112 of the annular flanges 11. Moreover, after the tire 10 is assembled to the bicycle wheel rim 1, each of the tire rim portions 101 of the tire 10 has only a relatively small outer surface region that frictionally abuts against the inner upright surface 113 and the curved surface 114 of a corresponding one of the annular flanges 11. The connection sections 123 of the outer ring wall 122 are unable to hold the tire rim portions 101 to continuously abut against the annular flanges 11. Therefore, the conventional bicycle wheel rim 1 may not provide a relatively secure and firm connection with the tire 10.

Another conventional bicycle wheel rim disclosed in U.S. Patent Application Publication No. 2009/0008986 includes a pair of annular flanges that extend radially and inwardly toward a central radial plane perpendicular to a rotation axis of the bicycle wheel rim for respectively and tightly abutting against tire rim portions of a tire. However, the tire rim portions still do not have sufficient regions to frictionally contact the bicycle wheel rim and cannot be held to continuously abut against the annular flanges.

### SUMMARY OF THE INVENTION

Therefore, an object of the present invention is to provide a bicycle wheel rim that can alleviate the aforesaid drawbacks of the prior art.

Another object of the present invention is to provide a bicycle wheel assembly including the bicycle wheel rim of this invention.

According to one aspect of this invention, a wheel rim is adapted for mounting a tire that has a pair of tire rim portions. The wheel rim includes abase portion and a pair of annular flanges.

The base portion has an inner ring wall surrounding a rotation axis of the wheel rim and an outer ring wall surrounding an outer circumference of the inner ring wall.

The annular flanges are disposed symmetrically and oppositely relative to a central radial plane perpendicular to the rotation axis of the wheel rim. Each of the annular flanges has an inclined inner surface adapted for abutting against a corresponding one of the tire rim portions.

The outer ring wall is disposed between the annular flanges, and includes a pair of connection sections, each of which is connected to a corresponding one of the annular flanges and has a retaining surface that extends from the corresponding one of the annular flanges toward the central radial plane of said wheel rim and that is gradually inclined radially and outwardly with respect to the rotation axis of the wheel rim. The retaining surface of each of the connecting sections cooperates with the inclined inner surface of the corresponding one of the annular flanges to form an included angle smaller than 90 degrees, and to clamp the corresponding one of the tire rim portions therebetween.

According to another aspect of this invention, a bicycle wheel assembly includes the abovementioned wheel rim mounted with the tire.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary sectional view of a conventional bicycle wheel rim for mounting a tire;

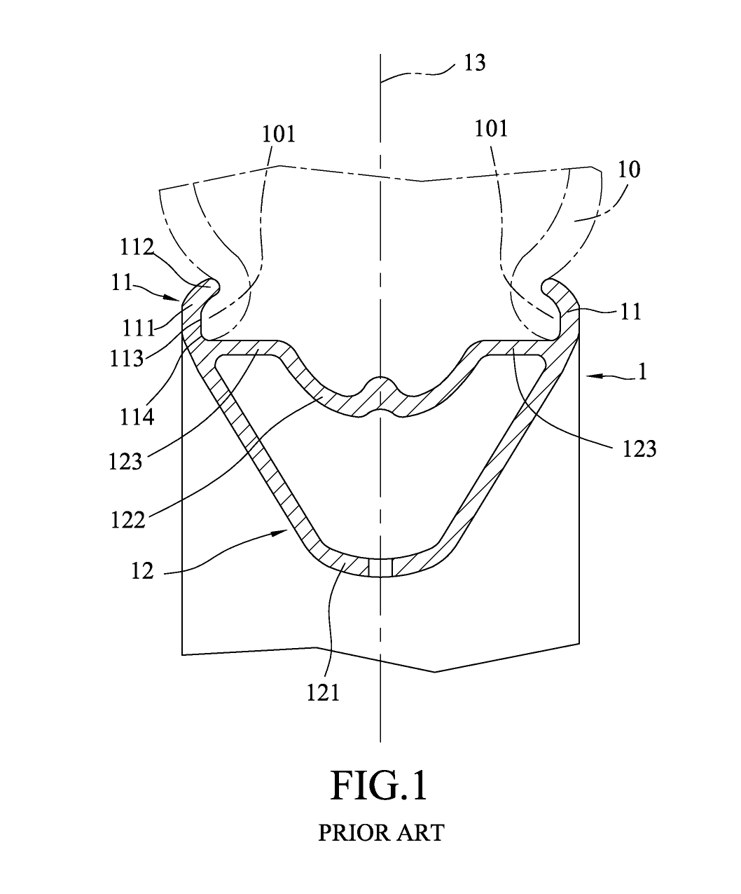

FIG. 2 is a fragmentary sectional view, illustrating the first preferred embodiment of a bicycle wheel rim according to the present invention;

FIG. 3 is an enlarged fragmentary sectional view of the first preferred embodiment; and

FIG. 4 is an enlarged fragmentary sectional view, illustrating the second preferred embodiment of a bicycle wheel rim according to the present invention.

### DETAILED DESCRIPTION OF THE PREFERRED EMBODIMENTS

Before the present invention is described in greater detail, it should be noted that like elements are denoted by the same reference numerals throughout the disclosure.

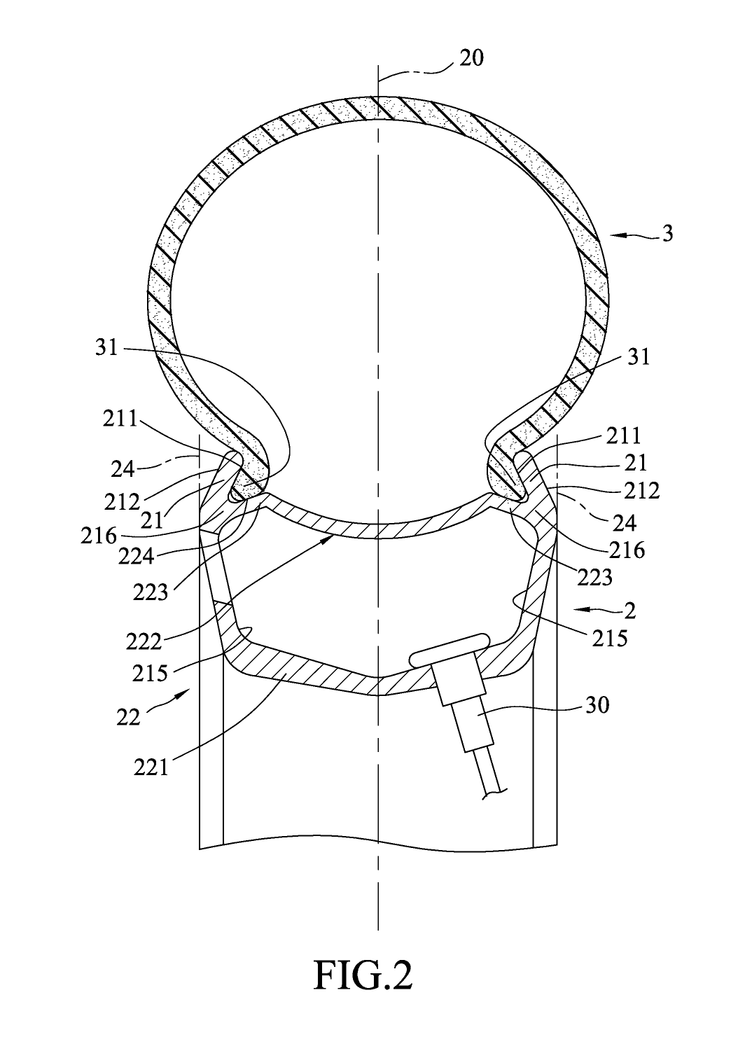

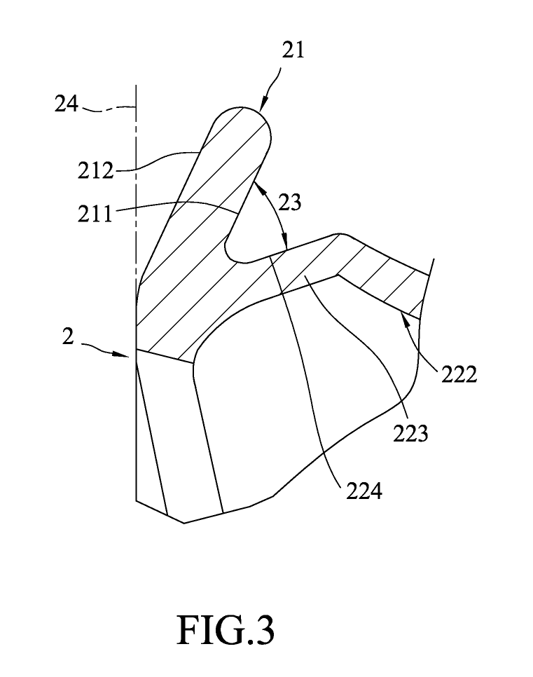

Referring to FIGS. 2 and 3, the first preferred embodiment of a bicycle wheel rim 2 according to the present invention is adapted for mounting a tire 3 and a plurality of wheel spokes 30 (only one is shown in FIG. 2). The tire 3 has a pair of tire rim portions 31 to be mounted on the wheel rim 2. The bicycle wheel rim 2 includes a base portion 22 and a pair of annular flanges 21.

The base portion 22 is a two-layer structure, and has an inner ring wall 221 surrounding a rotation axis of the wheel rim 2, and an outer ring wall 222 surrounding an outer circumference of the inner ring wall 221. The annular flanges 21 are disposed symmetrically and oppositely relative to a central radial plane 20 perpendicular to the rotation axis of the wheel rim 2. In this preferred embodiment, the tire rim portions 31 are symmetrically and oppositely disposed relative to the bicycle wheel rim 2. Each of the annular flanges 21 has an inclined inner surface 211 for abutting against a corresponding one of the tire rim portions 31.

In this preferred embodiment, the inner ring wall 221 is adapted for assembling with the wheel spokes 30. The outer ring wall 222 is disposed between the annular flanges 21 and includes a pair of connection sections 223, each of which is connected to a corresponding one of the annular flanges 21 and has a retaining surface 224 that extends from the corresponding one of the annular flanges 21 toward the central radial plane of said wheel rim 2 and that is gradually inclined radially and outwardly with respect to the rotation axis of the wheel rim 2. The retaining surface 224 of each of the connecting sections 223 cooperates with the inclined inner surface 211 of the corresponding one of the annular flanges 21 to form an included angle 23 smaller than 90 degrees, and to clamp the corresponding one of the tire rim portions 31 therebetween. Preferably, the included angle 23 is smaller than 85 degrees and larger than 45 degrees.

Preferably, the base portion 22 further includes a pair of annular intermediate walls 215 disposed respectively on two opposite sides of the central radial plane 20. Each of the annular intermediate walls 215 is connected between the inner and outer ring walls 221, 222 and extends outwardly from the inner ring wall 221 to the outer ring wall 222. The annular intermediate walls 215 have outermost projecting portions 216 proximate to the connection sections 223, respectively. Each of the annular flanges 21 is disposed between the central radial plane 20 and a respective one of two imaginary planes 24 that are parallel to the central radial plane 20 and that respectively extend through the outermost projecting portions 216. In this preferred embodiment, the annular flanges 21 are designed to be inclined radially, outwardly and respectively from the outermost projecting portions 216 toward the central radial plane 20. Accordingly, each of the annular flanges 21 has an outer surface 212 disposed parallel to the inclined inner surface 211 of the corresponding one of the annular flanges 21.

When the tire 3 is mounted on the bicycle wheel rim 2, since the included angles 23 are acute angles, each of the tire rim portions 31 is clamped firmly between the inclined inner surface 211 of a respective one of the annular flanges 21 and the retaining surface 224 of a corresponding one of the connection sections 223 of the outer ring wall 222.

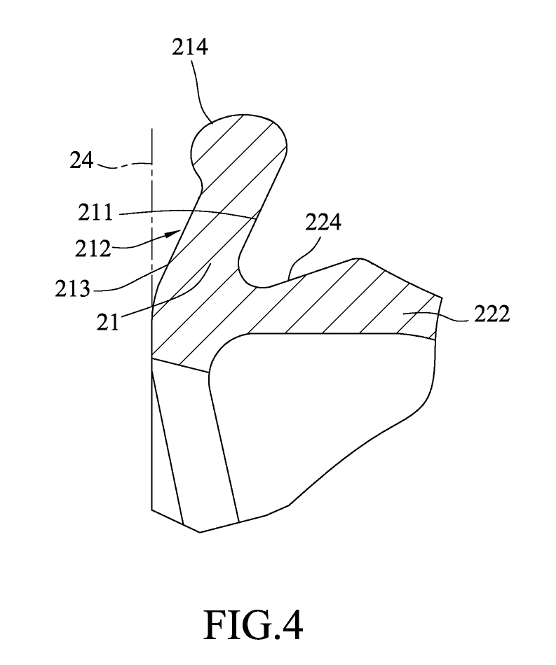

FIG. 4 shows the second preferred embodiment of a bicycle wheel rim 2 according to the present invention, which has a structure generally similar to that of the first preferred embodiment. However, in this embodiment, each of the annular flanges 21 has an outer surface 212 including an inclined section 213 that extends parallel to the inclined inner surface 211 and that has an inner end connected to the outer ring wall 222 and an outer end opposite to the inner end of the inclined section 213, and a protrusion 214 connected to the outer end of the inclined section 213. The protrusion 214 may be enlarged for increasing a structural strength of each annular flange 21. Preferably, the protrusion 214 of each annular flange 21 does not extend through a corresponding one of the imaginary planes 24.

To sum up, by virtue of the structural design of the bicycle wheel rim 2, the tire rim portions 31 of the tire 3 can be firmly secured by the annular flanges 21 and the connection sections 223 of the outer ring wall 222. Each of the tire rim portions 31 would have a relatively large outer surface region being in frictional contact with the retaining surfaces 224 and the inner surfaces 211, so that the problem of stress concentration between the tire rim portions 31 and the annular flanges 21 can be alleviated. Moreover, the frictional contact between the tire rim portions 31 and the bicycle wheel rim 2 also prevents detachment of the tire rim portions 31 from the wheel rim 2. Therefore, the thickness of the annular flanges 21 can even be reduced, thereby reducing the weight and size of the bicycle wheel rim 2.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A bicycle wheel rim adapted for mounting a tire that has a pair of tire rim portions, said bicycle wheel rim comprising:
a base portion having an inner ring wall surrounding a rotation axis of said bicycle wheel rim, and an outer ring wall surrounding an outer circumference of said inner ring wall; and
a pair of annular flanges disposed symmetrically and oppositely relative to a central radial plane perpendicular to the rotation axis of said bicycle wheel rim, each of said annular flanges having an inclined inner surface adapted for abutting against a corresponding one of the tire rim portions;
said outer ring wall being disposed between said annular flanges, and including a pair of connection sections, each of which is connected to a corresponding one of said annular flanges and has a retaining surface that extends from the corresponding one of said annular flanges toward the central radial plane of said wheel rim and that is gradually inclined radially and outwardly with respect to the rotation axis of said wheel rim, said retaining surface of each of said connecting sections cooperating with said inclined inner surface of the corresponding one of said annular flanges to form an included angle smaller than 90 degrees, and to clamp the corresponding one of the tire rim portions therebetween.

2. The bicycle wheel rim as claimed in claim 1, wherein said included angle is smaller than 85 degrees and larger than 45 degrees.

3. The bicycle wheel rim as claimed in claim 1, wherein said base portion further includes a pair of annular intermediate walls, which are disposed respectively on two opposite sides of the central radial plane and each of which is connected between said inner and outer ring walls and extends outwardly from said inner ring wall to said outer ring wall, said annular intermediate walls having outermost projecting portions proximate to said connection sections, respectively, each of said annular flanges being disposed between the central radial plane and a respective one of two imaginary planes that are parallel to the central radial plane and that respectively extend through said outermost projecting portions.

4. The bicycle wheel rim as claimed in claim 1, wherein each of said annular flanges has an outer surface disposed parallel to said inclined inner surface of the corresponding one of said annular flanges.

5. The bicycle wheel rim as claimed in claim 1, wherein each of said annular flanges has an outer surface including an inclined section that extends parallel to said inclined inner surface of the corresponding one of said annular flanges and that has an inner end connected to said outer ring wall and an outer end opposite to said inner end of said inclined section, and a protrusion that is connected to said outer end of said inclined section.

6. A bicycle wheel assembly comprising:
a tire that has a pair of tire rim portions; and
a bicycle wheel rim that includes
a base portion having an inner ring wall surrounding a rotation axis of said bicycle wheel rim, and an outer ring wall surrounding an outer circumference of said inner ring wall; and
a pair of annular flanges disposed symmetrically and oppositely relative to a central radial plane perpendicular to the rotation axis of said bicycle wheel rim, each of said annular flanges having an inclined inner surface abutting against a corresponding one of said tire rim portions;
said outer ring wall being disposed between said annular flanges, and including a pair of connection sections, each of which is connected to a corresponding one of said annular flanges and has a retaining surface that extends from the corresponding one of said annular flanges toward the central radial plane of said wheel rim and that is gradually inclined radially and outwardly with respect to the rotation axis of said bicycle wheel rim, said retaining surface of each of said connecting sections cooperating with said inclined inner surface of the corresponding one of said annular flanges to form an included angle smaller than 90 degrees, and to clamp the corresponding one of said tire rim portions.
